(19) United States
(12) Patent Application Publication
(10) Pub. No.: US 2011/0308479 A1
(43) Pub. Date: Dec. 22, 2011

(54) Pet holder

(76) Inventor: Albert Kuo, Chino Hills, CA (US)

(21) Appl. No.: 12/803,211

(22) Filed: Jun. 21, 2010

(51) Int. Cl. A01K 27/00

(52) U.S. Cl. 119/792; 119/863

(57) ABSTRACT

A pet holder for a pet including a harness body adapted for being worn by the pet at a torso thereof and a restraint holder extended from the harness body at a position close to hind legs of the pet to shorten a torque distance between the hind legs and said restraint holder, wherein the restraint holder is adapted to be held for rapidly and directly applying a controlling force towards the hind legs of the pet such that the restraint holder forms a quick-and-proper control of constraint when handling the pet.

### BACKGROUND OF THE PRESENT INVENTION

1. Field of Invention

The present invention is related to a pet leash, and more particularly to the pet holder, which provides a holding member for being attached to a rear back of the pet, such as dog, so that the user is able to efficiently apply a dragging force for controllably restraining the pet.

2. Description of Related Arts

The keeping animal, such as horse, cat, or dog, as pet for human companions has a long history. Take the dog as an example, which has become one of the most popular companions for human beings, for example. Many families choose the dog for guarding the house, playing with their kid as playmate, or having companions for supporting the emotions of human.

In order to control and restraint the wild nature of the dog as one of the examples, there are variety of types pet physical controlling gadgets are provided, so that the human is able to train and keep their pet to fit into the human society, so as to prevent any accidents happened on the pet or the human being.

The most common controlling gadget for restraint the pet is leash, wherein the leash is commonly provided for clipping onto a collar, which is detachably being worn on the neck portion of the dog, in such a manner that human being is able to pull or drag the leash in order to control the direction of the dog while walking the dog. Moreover, it is important for the dog to be on leash in public, so that the leash is able to prevent the dog running away from the owner and become a homeless dog to cause more social problems. Also, the dog on leash can also prevent the dog accidentally endangering the traffic, such as being accidentally hit by car.

However, the leash detachably attaching to the collar for controlling the movement of dog may still have some potential issues and concerns. For the middle or large size of dog, the pulling or dragging mechanism between human and dog via the leash may not be efficiently for the human holding onto the leash to securely control or restraint the dog. One of the major drawbacks of the mechanism of attaching the leash on the neck portion of pet is the relatively longer torque distance from the strong hind legs to the neck portion thereof. Therefore, the sudden initial sprinting force at the strong hind legs of the dog will hurt the neck portion thereof when the neck portion of the dog is held by the leash tightly. Otherwise, the leash may be accidentally slipped out of the holding hands of the pet owner, so as to lose the pet dog.

Take the strong large sized shepherd or retriever dog for example. This breed of dog may have stronger hind legs having the instinct for retrieving prey, so that when they sense any other animal as the prey nearby, they may instantaneously and powerfully jump or run after the prey and pull the leash with excessive force from the hind legs. Therefore, the owner of the pet may not be able to securely hold onto the leash when the strong and powerful pet dog is unexpectedly pulling the leash. The owner of the pet may be also dragged by the dog to be accidentally injured.

### SUMMARY OF THE PRESENT INVENTION

The invention is advantageous in that it provides a pet holder, which is able to efficiently apply a greater controlling force over the pet for controllably restraint the pet, so as to enhance the security and comfortableness while walking, running, or training the pet on leash.

Another advantage of the invention is to provide a pet holder, wherein the restraint holder forms a quick-and-proper control of constraint when handling the pet by applying the controlling force at the restraint holder.

Another advantage of the invention is to provide a pet holder, wherein the rear restraint holder provided at the rear back portion of the pet is able to shorten the torque distance between the hind legs of the pet and the holding hand of handler, so as to efficiently apply the controlling force over the pet.

Another advantage of the invention is to provide a pet holder, wherein a restraining ring is provided at the harness body at a back of the pet close to a croup thereof for detachably coupling with a restraining leash for handling the pet by adjustably shortening the torque distance between the pet and the handler.

Another advantage of the invention is to provide a pet holder, wherein the handler is able to apply an essentially upward pulling force, a rearward dragging force, or downward pushing force at the restraint holder adjacent to the hind legs of the pet, especially for the pets having stronger hind legs and mainly using hind legs as the force fulcrum for instantaneously and explosively using the muscle of hind legs. Therefore, the handler is able to efficiently apply the force at the restraint holder adjacent to fulcrum of the hind legs and to shorten the torque distance between the fulcrum and the restraint holder, so that the pet holder is able to be securely held thereat even when the pet is unexpectedly pulling with large force.

Another advantage of the invention is to provide a pet holder, wherein the harness body is adapted for fittingly worn by the pet by wrapping around a rear portion of the pet in front of the hind legs thereof via a size-adjustable rear strap loop and by wrapping around a front portion of the pet via a size-adjustable front strap loop. Therefore, the pet can comfortably wear the body harness while the handler can easily restraint the pet by evenly distributing the controlling force for the pet.

Another advantage of the invention is to provide a pet holder, wherein the pet holder is adapted for incorporating with any exiting leash.

Another advantage of the invention is to provide a pet holder, which is able to assist restraining and disciplining the pet to prevent the pet out of control.

Another advantage of the invention is to provide a pet holder, wherein no expensive or complicated structure is required to employ in the present invention in order to achieve the above mentioned objects. Therefore, the present invention successfully provides an economic and efficient solution for leashing the pet and restraining the pet at the same time.

Additional advantages and features of the invention will become apparent from the description which follows, and may be realized by means of the instrumentalities and combinations particular point out in the appended claims.

According to the present invention, the foregoing and other objects and advantages are attained by providing a pet holder which comprises a body strap for being fittingly worn by the pet, and a restraint holder for being gripped by the handler hand, so as to control and restraint the movement or behavior of the pet.

The restraint holder is extended from the harness body at a position close to hind legs of the pet to shorten a torque distance between the hind legs and the restraint holder, wherein the restraint holder is adapted to be held for rapidly and directly applying a controlling force towards the hind legs of the pet such that the restraint holder forms a quick-and-proper control of constraint when handling the pet.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pet holder according to a first preferred embodiment of the present invention, illustrating the pet holder incorporating with a pet and being held by a handler.

FIG. 2 is a top perspective view of the pet holder according to the first preferred embodiment of the present invention.

FIG. 3 is a perspective view of a pet holder according to a second preferred embodiment of the present invention, illustrating the pet holder incorporating with a pet and being held by a handler.

FIG. 4 is a top perspective view of the pet holder according to the second preferred embodiment of the present invention.

FIG. 5 is a perspective view of a pet holder according to a third preferred embodiment of the present invention, illustrating the pet holder for a relatively smaller size pet.

### DETAILED DESCRIPTION OF THE PREFERRED EMBODIMENT

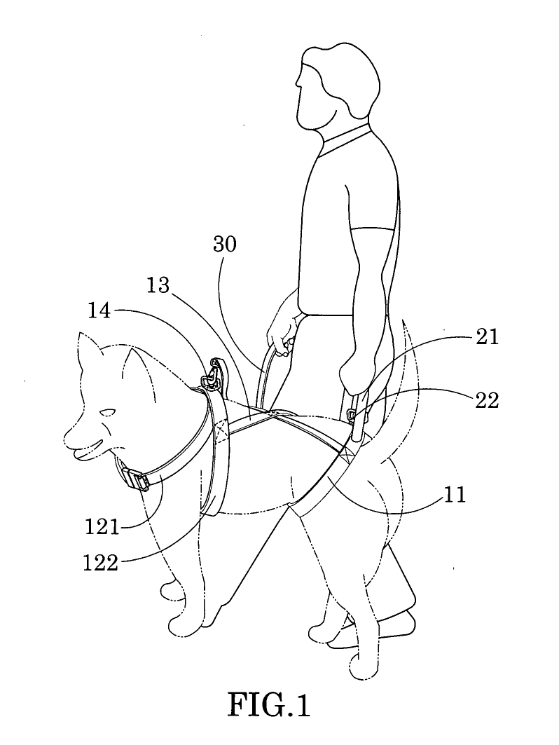

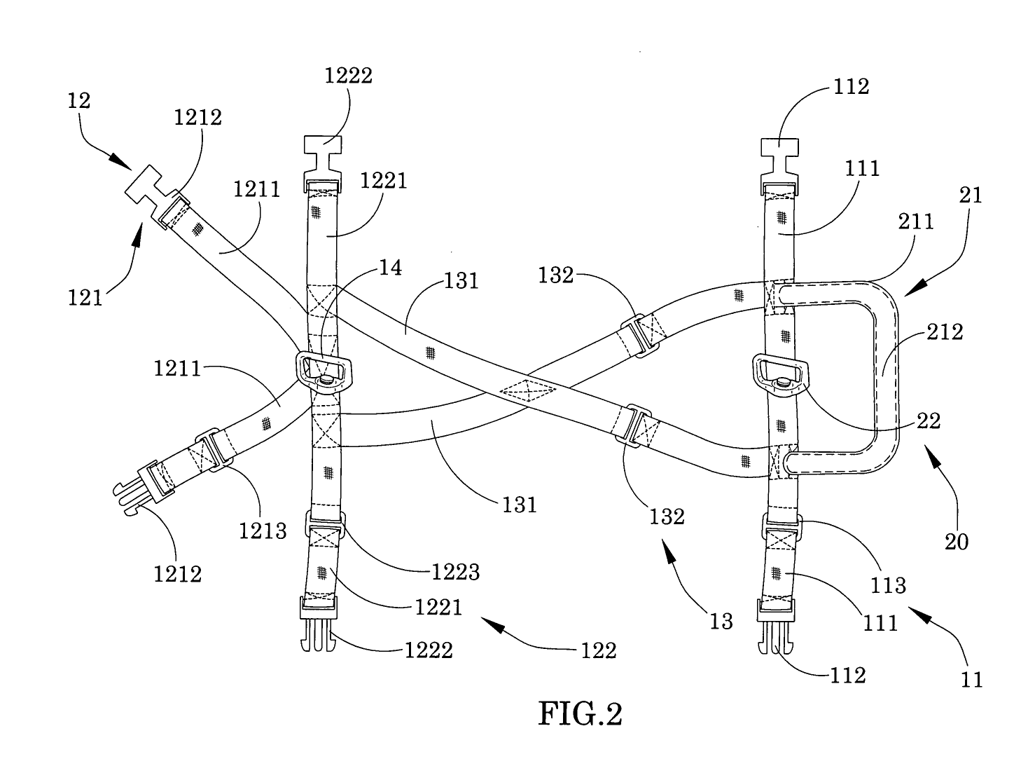

Referring to FIGS. 1 to 2 of the drawings, a pet holder for efficiently controlling a movement or behavior of pet according to a preferred embodiment of the present invention is illustrated, wherein the pet holder allows a handler, such as a pet owner, to apply a relatively stronger controlling force over the pet with the same strength that the handler applied on the pet holder, especially for relatively larger size pet mainly using stronger hind legs as a fulcrum of the movement, such as middle or large size pet dog.

The pet holder comprises a harness body 10 for being fittingly worn on the pet to surround a torso of the pet, and a restraint holder 20 extended from the harness body 10 at a position close to hind legs of the pet to shorten a torque distance between the hind legs and the restraint holder 20. Accordingly, the restraint holder 20 is adapted to be held for rapidly and directly applying a controlling force towards the hind legs of the pet such that the restraint holder 20 forms a quick-and-proper control of constraint when handling the pet

As shown in FIGS. 1 and 2, the restraint holder 20 is secured at top of the harness body 10 at a position adjacent to a rear part of the torso, in such a manner that the restraint holder 20 is able for being gripped thereat to transfer the controlling force from the restraint holder 20 to the pet. Therefore, the torque distance between the fulcrum of the movement of pet adjacent to the hind legs thereof and the restraint holder 20 is shortened to minimize the needed strength of the user and transfer the strength into effective controlling force in a maximized manner.

As a result, the restraint holder 20 is adapted for being gripped thereat to apply the controlling force over the pet via the restraint holder 20, by means of applying an upward lifting force at the restraint holder 20 to lift up the hind legs of the pet, a relatively less rearward dragging force at the restraint holder 20 to stop the movement of the pet, or a downward pushing force at the restraint holder 20 to push down the croup of the pet.

According to the preferred embodiment of the present invention, the harness body 10 comprises a size-adjustable rear strap loop 11 adapted for wrapping around a rear portion of the pet in front of the hind legs thereof, a size-adjustable front strap loop 12 adapted for wrapping around a front portion of the pet, and a size-adjustable body strap 13 extended between the rear strap loop 11 and the front strap loop 12 for being fittingly worn by the pet, so as to evenly distribute the controlling force applied on the restraint holder 20 over the pet. As a result, the harness body 10 is able to be fittingly worn the pet in a universal manner.

As shown in FIGS. 1 and 2, the body strap 13 comprises a “X” shaped back strap 131 extending between the rear strap 11 and the front strap loop 12 and longitudinally and securely providing on the top of back portion of the torso of the pet. The body strap 13 further comprises two body strap adjustors 132 operatively provided at the back strap 131 to selectively adjust the length of the back strap 131 between the rear strap 11 and the front strap loop 12.

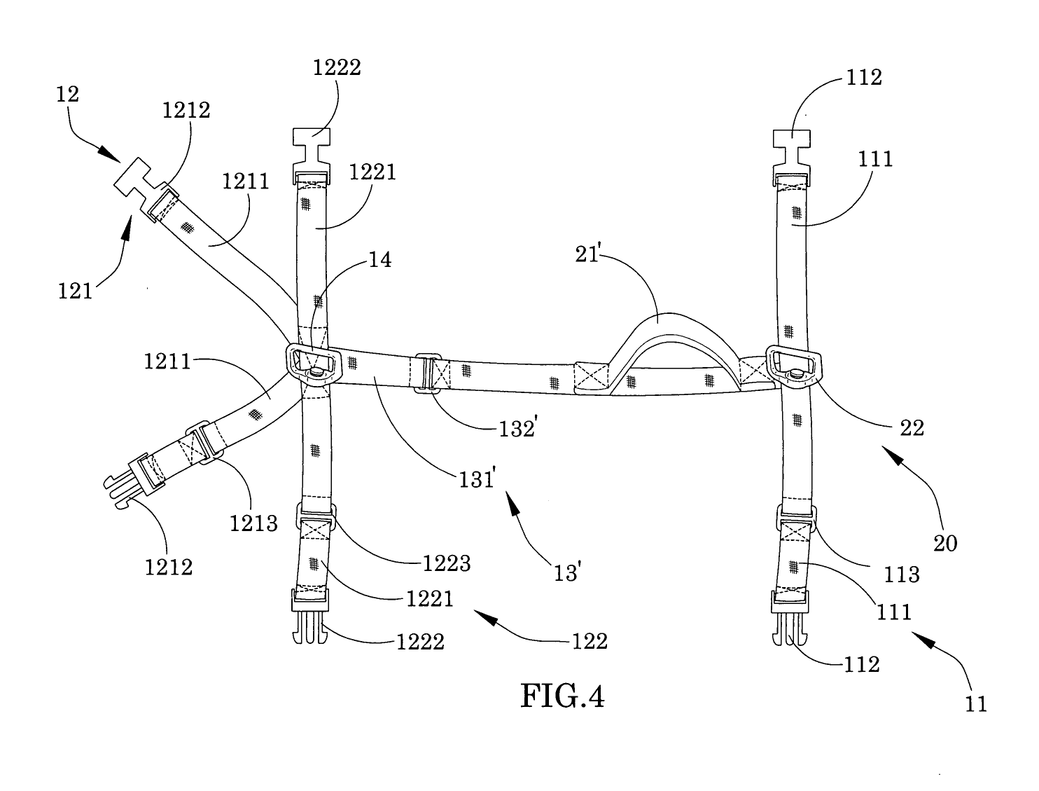

Alternatively, the body strap 13′ comprises an elongated back strap 131′ extending between the rear strap loop 11 and the front strap loop 12 and longitudinally and securely providing on the top of back portion of the torso of the pet. The body strap 13′ further comprises a body strap adjustor 132′ operatively provided at the back strap 131′ to selectively adjust the length of the back strap 131′ between the rear strap 11 and the front strap loop 12, as shown in FIG. 4.

The rear strap loop 11 is formed by extending two rear straps 111 from the rear portion of the body strap 13 and two rear fasteners 112 provided at two free ends of the rear straps 111. When the rear fasteners 112 are detachably fastened with each other, the rear straps 111 are coupled to form the rear strap loop 11. The rear strap loop 11 further comprises at least a rear strap adjustor 113 provided at one of the rear straps 111 to selectively adjust the loop size of the rear strap loop 11.

The front strap loop 12 comprises a comprises a size-adjustable collar strap loop 121 extended from the body strap 13 for wrapping around a collar of the pet and a size-adjustable front chest loop 122 extended from the body strap 13 for wrapping around a chest of the pet. Accordingly, the collar strap loop 121 comprises two collar straps 1211 extending from the body strap 13 and two collar strap fasteners 1212 provided at two free ends of the collar straps 1211 respectively, such that when the collar straps fasteners 1212 are detachably fastened with each other, the collar straps 1211 are coupled to form the collar strap loop 121. The collar strap loop 121 further comprises a collar strap adjustor 1213 provided at one of the collar straps 1211 to selectively adjust the loop size of the collar strap loop 121.

Likewise, the front chest loop 122 comprises two chest straps 1221 extending from the body strap 13 and two chest strap fasteners 1222 provided at two free ends of the chest straps 1221 respectively, such that when the chest straps fasteners 1222 are detachably fastened with each other, the chest straps 1221 are coupled to form the chest strap loop 122. The chest strap loop 121 further comprises a chest strap adjustor 1223 provided at one of the chest straps 1221 to selectively adjust the loop size of the chest strap loop 122.

As will be readily appreciated by one skilled in the art, the harness body 10 could be one piece of material, such as leather, extendedly surrounding from the back portion to a bottom of the torso of the pet for fittingly and securely being worn by the pet, so that the holding member 21 is able to be secured and position on the top of the harness body 10 adjacent to the hind legs of the pet, so as to efficiently apply the controlling force thereat. The harness body 10 could also be a garment fittingly being worn on the pet for secure and position the holding member 21 thereat.

According to the preferred embodiment, the restraint holder 20 comprises an inverted U-shaped holding member 21 upwardly extended from the harness body 10 at a back of the pet close to a croup thereof, and elevated from the harness body 10 with a predetermined height adapted for being reached by the hand of the handler.

As shown in FIG. 2, the holding member 21 has two ends spacedly fastening at the rear strap loop 11 at a position that the holding member 21 is transversely positioned on top of the pet. In other words, the holding member 21 is provided on the top of the rear strap loop 11, so that the controlling force is able to apply on the holding member 21, which is located at a location close to the hind legs of the pet, so as to shorten the torque distance for maximizing the effective controlling force on the pet via the holding member 21. It is worth mentioning that since the rear strap loop 11 is adjusted to fit for wrapping around the rear portion of the pet in front of the hind legs thereof, the holding member 21 is retained close to the hind legs of the pet, so as to minimize the unwanted lateral movement of the holding member 21.

In particularly, the holding member 21 is integrally extended from the rear strap loop 11 and is made of stiff material for enabling the holding member 21 being retained at an upright manner. Therefore, the holding member 21 can be easily gripped and held for applying the controlling force over the pet.

According to the preferred embodiment, the holding member 21 comprises a flexible receiving pocket 211 integrally fastened at the rear strap loop 11 and a stiff retention member 212 disposed in the receiving pocket 211 to retain the holding member 21 at an upright manner. Therefore, the handler is able to comfortably grip the holding member 21 when the handler is standing next to the pet side by side.

On the other hand, the handler can directly grip the holding member 21 and to apply the controlling force, such as vertically applying lifting force at the holding member 21, adjacent to the fulcrum of the pet movement at the hind legs. Therefore, the torque distance is minimized to reduce the required torque force for controlling the movement of the pet.

It should be noted that the holding member 21 may also be used for training or restraint the behavior, such as stand or sit, wherein pet holder enables the holding member being held to apply the vertical lifting force and the downwardly vertical pushing force of the controlling force on the rear part of the torso, so as to assist the pet to complete the commons of stand and sit by the holding member 21.

It is worth to mention that the holding member 21 may be made of soft material, such as fabric; ridged material, such as steel; or semi-ridged material, such as leather according to the applications of the holding member 21.

The restraint holder 20 further comprises a restraining ring 22 upwardly extended from the harness body 10 at a back of the pet close to a croup thereof for detachably coupling with a restraining leash 30. Accordingly, the restraining ring 22 is located at the rear strap loop 11 at a position between the two ends of the holding member 21′. Therefore, the handler has an option to fasten the restraining leash 30 with the harness body 10 at the restraining ring 22 to minimize the distance between the pet and the handler via the length of the restraining leash 30.

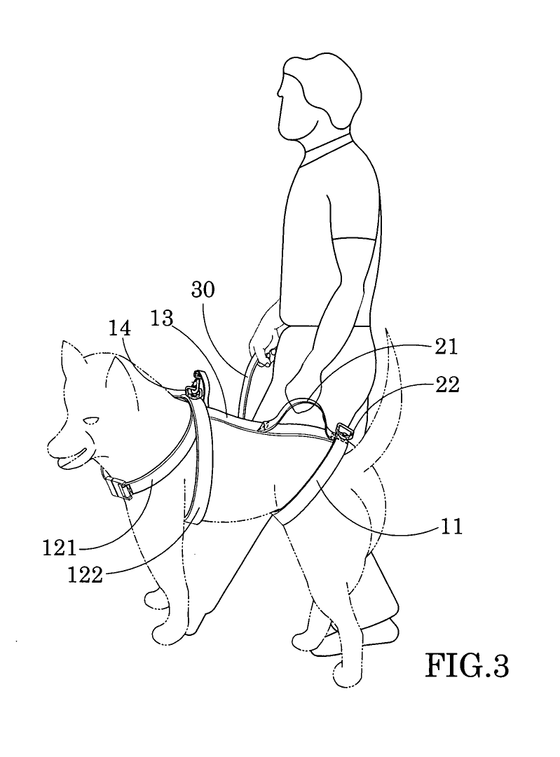

FIGS. 3 and 4 illustrates an alternative mode of the restraint holder 20′ which comprises an inverted U-shaped holding member 21′ upwardly extended from the harness body 10 at a back of the pet close to a croup thereof, and elevated from the harness body 10 with a predetermined height adapted for being reached by a hand of a handler. In particularly, the holding member 21′ is upwardly extended from the back trap 131′ of the body strap 13′ and is extended in a longitudinal direction between the rear strap loop 11 and the front strap loop 12. In other words, the holding member 21′ has two ends spacedly fastening at the body strap 13′ at a position that the holding member 21′ is longitudinally positioned on top of the pet. As shown in FIG. 4, the holding member 21′ is integrally extended from the body strap 13′ and is made of stiff material for enabling the holding member 21′ being retained at an upright manner. Preferably, the holding member 21′ is made of stiff fibrous material such as nylon sewn to the body strap 13′. It is worth mentioning that the restraining ring 22 is provided at the harness body 10 at a position behind the holding member 21′.

It is worth mentioning that the above embodiment and its alternatives can be interchanged.

According to the preferred embodiment, the harness body 10 further comprises a leash ring 14 provided at the front strap loop 12 for detachably coupling with a controlling leash.

The controlling leash, such as a dog leash, is able to detachably couple with the leash ring 14 for the assistance of the controlling the movement of the pet. Therefore, the pet holder is able to controllably applying the controlling force at the front side of harness body 10 for controlling the moving direction of the pet while applying the controlling force at the holding member 21 to efficiently minimize the strength of the user for controlling the movement. It is worth mentioning that the length of the controlling leash should be longer than the length of the restraining leash 30 since the controlling leash is coupled at the front strap loop 12 while the restraining leash 30 is coupled at the rear strap loop 11. Accordingly, the controlling leash can be the restraining leash 30 by shortening the length of the restraining leash 30.

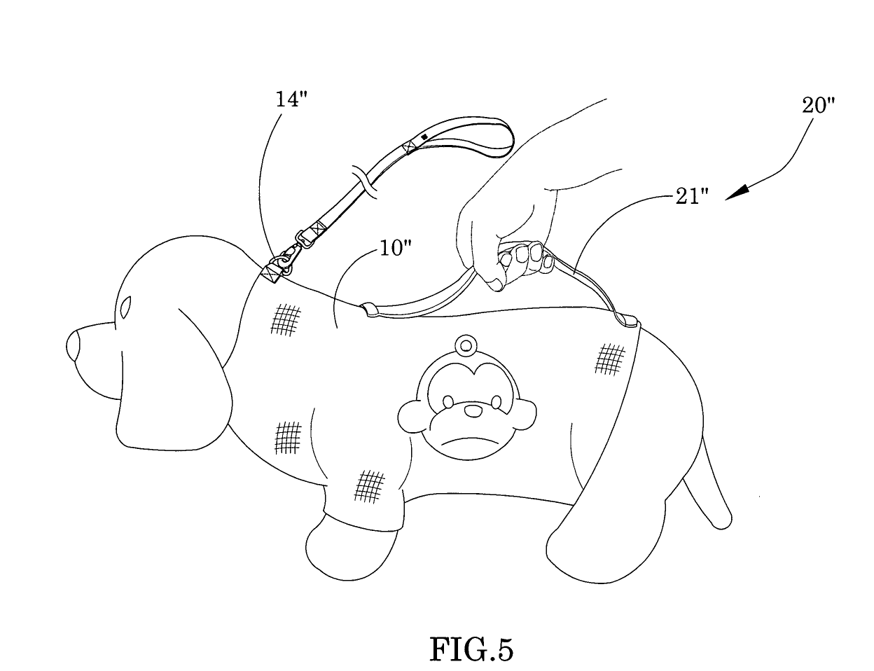

FIG. 5 illustrates another alternative mode of the pet holder which is adapted especially for a smaller sized pet being worn, wherein the pet holder comprises a harness body 10″ and a restraint holder 20″.

As shown in FIG. 5, the harness body 10″ is embodied as a harness vest being comfortably worn by the pet and made of washable garment. The harness body 10″ further comprises a leash ring 14″ provided at the front portion of the harness body 10″ for detachably coupling with the controlling leash. Therefore, the controlling leash is able to detachably couple with the leash ring 14″ for the assistance of the controlling the movement of the pet.

The restraint holder 20″ comprises an inverted U-shaped holding member 21″ upwardly extended from the harness body 10″ at a back of the pet close to a croup thereof and extended in a longitudinal direction between the rear body and the front body of the pet. In other words, the holding member 21″ is longitudinally positioned on top of the pet. As shown in FIG. 5, the holding member 21″ is integrally extended from the harness body 10″ and is made of stiff material for enabling the holding member 21″ being retained at an upright manner. Preferably, the holding member 21″ is made of stiff fibrous material such as nylon sewn to the harness body 10″.

Therefore, the pet holder is able to controllably applying the controlling force at the front side of harness body 10″ via the leash ring 14″ for controlling the moving direction of the pet. In addition, the pet holder is able to lift up the pet by applying an upward lifting force as the controlling force at the holding member 21″ such that the pet holder can easily pick up the pet. It is worth mentioning that picking up the pet is necessary when the pet is injured or the pet cannot walk its own. Traditionally, the pet holder must put his or her beneath the body of the pet in order to pick up the pet. However, when the pet is injured or lies on the ground, unnecessary force may be applied to the pet to agitate the pet or to complicate its injury when the pet is picked up. Therefore, the holding member 21″ provides a manageable way for the pet holder to easily pick up the pet.

It is appreciated that the restraint holder 20, 20′ of the first and second embodiment can incorporate with the harness vest of the harness body 10″ of the third embodiment, wherein the larger sized pet can wear the harness vest of the harness body 10″ while the restraint holder 20, 20′ is extended from the harness body 10″ at a position close to hind legs of the pet.

According to the preferred embodiment, the handler is able to apply an essentially upward pulling force to lift up the hind legs of the pet, a rearward dragging force to stop the movement of the hind legs of the pet, or downward pushing force to force the pet to sit. Therefore, the pet holder provides a quick-and-proper control via the restraint holder 20 for constraint when handling the pet. The pet holder of the present invention can be used especially for the pets having stronger hind legs and mainly using hind legs as the force fulcrum for instantaneously and explosively using the muscle of hind legs.

The handler is able to efficiently apply the force at the restraint holder 20 adjacent to fulcrum of the hind legs and to shorten the torque distance between the fulcrum and the restraint holder, so that the pet holder is able to be securely held thereat even when the pet is unexpectedly pulling with large force.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pet holder for pet, comprising:
a harness body adapted for being worn by the pet at a torso thereof; and
a restraint holder extended from said harness body at a position close to hind legs of the pet to shorten a torque distance between the hind legs and said restraint holder, wherein said restraint holder is adapted to be held for rapidly and directly applying a controlling force towards the hind legs of the pet such that said restraint holder forms a quick-and-proper control of constraint when handling the pet.

2. The pet holder, as recited in claim 1, wherein said harness body comprises a size-adjustable rear strap loop adapted for wrapping around a rear portion of the pet in front of the hind legs thereof, a size-adjustable front strap loop adapted for wrapping around a front portion of the pet, and a size-adjustable body strap extended between said rear strap loop and said front strap loop for being fittingly worn by the pet.

3. The pet holder, as recited in claim 1, wherein said restraint holder comprises an inverted U-shaped holding member upwardly extended from said harness body at a back of the pet close to a croup thereof, and elevated from said harness body with a predetermined height adapted for being reached by a hand of a handler.

4. The pet holder, as recited in claim 2, wherein said restraint holder comprises an inverted U-shaped holding member upwardly extended from said harness body at a back of the pet close to a croup thereof, and elevated from said harness body with a predetermined height adapted for being reached by a hand of a handler.

5. The pet holder, as recited in claim 4, wherein said holding member has two ends spacedly fastening at said rear strap loop at a position that said holding member is transversely positioned on top of the pet.

6. The pet holder, as recited in claim 5, wherein said holding member is integrally extended from said rear strap loop and is made of stiff material for enabling said holding member being retained at an upright manner.

7. The pet holder, as recited in claim 6, wherein said holding member comprises a flexible receiving pocket integrally fastened at said rear strap loop and a stiff retention member disposed in said receiving pocket to retain said holding member at an upright manner.

8. The pet holder, as recited in claim 4, wherein said holding member has two ends spacedly fastening at said body strap at a position that said holding member is longitudinally positioned on top of the pet.

9. The pet holder, as recited in claim 8, wherein said holding member is integrally extended from said body strap.

10. The pet holder, as recited in claim 9, wherein said holding member and is made of stiff fibrous material for enabling said holding member being retained at an upright manner.

11. The pet holder, as recited in claim 2, wherein said restraint holder comprises a restraining ring upwardly extended from said harness body at a back of the pet close to a croup thereof for detachably coupling with a restraining leash.

12. The pet holder, as recited in claim 7, wherein said restraint holder further comprises a restraining ring upwardly extended from said harness body at a back of the pet close to a croup thereof for detachably coupling with a restraining leash.

13. The pet holder, as recited in claim 10, wherein said restraint holder further comprises a restraining ring upwardly extended from said harness body at a back of the pet close to a croup thereof for detachably coupling with a restraining leash.

14. The pet holder, as recited in claim 12, wherein said restraining ring is provided at said rear strap loop.

15. The pet holder, as recited in claim 13, wherein said restraining ring is provided at said rear strap loop.

16. The pet holder, as recited in claim 11, wherein said harness body further comprises a leash ring provided at said front strap loop for detachably coupling with a controlling leash.

17. The pet holder, as recited in claim 14, wherein said harness body further comprises a leash ring provided at said front strap loop for detachably coupling with a controlling leash.

18. The pet holder, as recited in claim 15, wherein said harness body further comprises a leash ring provided at said front strap loop for detachably coupling with a controlling leash.

19. The pet holder, as recited in claim 17, wherein said harness body further comprises two rear straps sidewardly extended from said body strap and two rear fasteners provided at two free ends of said rear straps respectively to form said rear strap loop when said rear fasteners are detachably fastened with each other, wherein said front strap loop comprises a size-adjustable collar strap loop extended from said body strap for wrapping around a collar of the pet and a size-adjustable front chest loop extended from said body strap for wrapping around a chest of the pet.

20. The pet holder, as recited in claim 18, wherein said harness body further comprises two rear straps sidewardly extended from said body strap and two rear fasteners provided at two free ends of said rear straps respectively to form said rear strap loop when said rear fasteners are detachably fastened with each other, wherein said front strap loop comprises a size-adjustable collar strap loop extended from said body strap for wrapping around a collar of the pet and a size-adjustable front chest loop extended from said body strap for wrapping around a chest of the pet.
